(19) United States
(12) Patent Application Publication
(10) Pub. No.: US 2023/0289478 A1
(43) Pub. Date: Sep. 14, 2023

(54) GENERATING SIGNED MEASUREMENTS

(71) Applicant: Hewlett-Packard Development Company, L.P., Spring, TX (US)

(72) Inventors: Joshua Serratelli Schiffman, Washington, DC (US); Carey Huscroft, Bristol (GB); Gaetan Wattiau, Bristol (GB)

(73) Assignee: Hewlett-Packard Development Company, L.P., Spring, TX (US)

(21) Appl. No.: 18/041,181

(22) PCT Filed: Aug. 28, 2020
(86) PCT No.: PCT/US2020/048391

§ 371 Date: Feb. 9, 2023

(51) Int. Cl. G06F 21/64; G06F 21/60; G06F 21/44

(52) U.S. Cl. CPC G06F 21/64; G06F 21/44; G06F 21/602

(57) ABSTRACT

In an example, a tangible machine-readable medium includes instructions which, when executed on at least one processor, cause the at least one processor to obtain an attestation public key bound to an identity associated with a root of trust of a platform. The instructions further cause the at least one processor to obtain a trusted time stamp associated with data collection by the platform. The instructions further cause the at least one processor to generate a signed measurement based on a trusted input as a nonce.

### BACKGROUND

During assembly of a computing device by an original design manufacturer (ODM), information such as diagnostic data acquired when performing an installation on the computing device may be sent to an original equipment manufacturer (OEM). This information may be used by the OEM for asset tracking.

### BRIEF DESCRIPTION OF DRAWINGS

Non-limiting examples will now be described with reference to the accompanying drawings, in which:

FIG. 1 is a simplified schematic illustration of an example machine-readable medium associated with a processor;

FIG. 2 is a simplified schematic illustration of an example machine-readable medium associated with a processor;

FIG. 3 is a simplified schematic illustration of an example apparatus for implementing certain methods;

FIG. 4 is a simplified schematic illustration of an example apparatus for implementing certain methods;

FIG. 5 is a flowchart of an example method for verifying certain information about a platform;

FIG. 6 is a flowchart of an example method for verifying certain information about a platform;

FIG. 7 is a simplified schematic illustration of an example apparatus for implementing certain methods; and

FIG. 8 is a simplified schematic illustration of an example apparatus for implementing certain methods.

### DETAILED DESCRIPTION

ODM factories may assemble computing devices from multiple OEMs in a generally untrusted environment. OEMs may wish to collect information about their products which have been supplied to the ODM factories.

After assembly, a computing device may be booted from a network-downloaded image (e.g., a network-installed diagnostics operating system) for performing diagnostics and/or other data collection on the computing device. As part of the ‘end of line’ diagnostics, data (or ‘actuals’) about an assembled computing device may be collected. The data may include information about the hardware components, software and/or firmware, and other configuration data of the computing device. In addition, the diagnostics run on each unit (which may occur multiple times) at the end of the manufacturing process may be used to ‘qualify’ that the computing device is in an expected state.

This data may be sent to the OEM for asset tracking, for example, via a staging server that may not be controlled by the OEM. However, due to the cost, network limitations and/or security concerns relating to the factory, the data from multiple computing devices may be saved in a batch at a staging server within the factory that may regularly upload bulk data to the OEM (e.g., several times a day). Once received by the OEM, the data may be parsed for each computing device and an OEM-controlled asset database updated accordingly.

The OEM may not know the identity of the computing device at the time the computing device submits the data to the staging server. Without there being a pre-provisioned identity for the computing device in the factory, the OEM may not be able to authenticate that the data it receives from the staging server is trusted or indeed from the computing device. Although the computing device may include a secure component with corresponding cryptographic keys, these identities may not be known to the OEM ahead of assembly time in the factory. In theory, any entity could potentially submit data to the staging server. Therefore, an OEM may be unable to completely trust the data it receives from the staging server due to the possibility that a network adversary could try to submit falsified data to the OEM. In some examples, it may be feasible for an attacker to swap the reported endorsement key (EK) associated with a trusted platform module (TPM) with an attacker controlled EK. The reported data could also include changes to as built data values and/or facilitate an attack on an asset database controlled by an OEM, for example, including hiding evidence of illicit components.

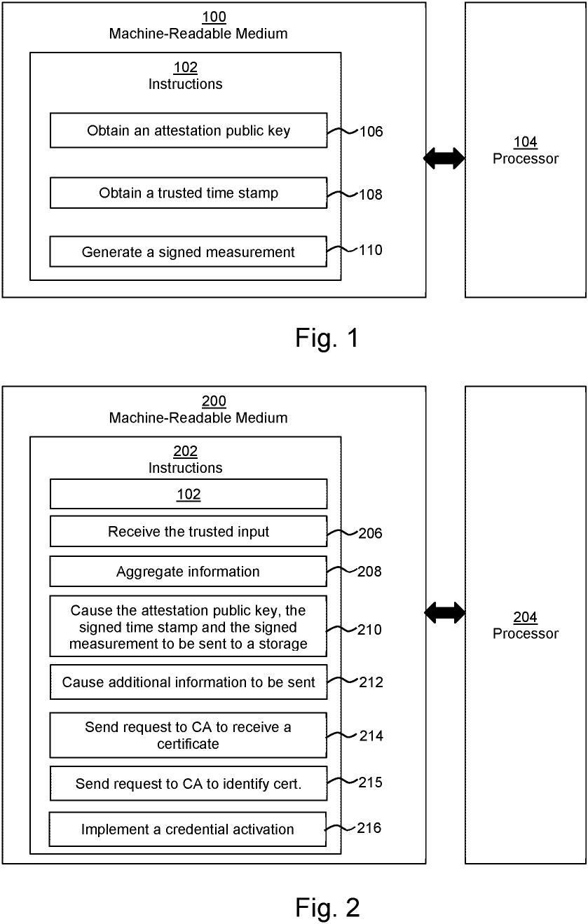

FIG. 1 schematically illustrates a machine-readable medium 100 (e.g., a tangible machine-readable medium) which stores instructions 102, which when executed by at least one processor 104, cause the at least one processor 104 to carry out certain methods described herein.

In some examples, the machine-readable medium 100 may be implemented by a platform such as a computing device (e.g., a personal computer, laptop, smart device such as a smart phone or other computing device which an OEM might need to authenticate). For example, the computing device may comprise a secure component comprising the machine-readable medium 100.

The secure component, which is an example of a root of trust, may be capable of facilitating a remote cryptographic authentication procedure where a trusted entity can establish whether or not data provided by the secure component is indeed derived from the secure component.

In some examples, the secure component may comprise or be implemented as a trusted platform module (TPM), smart card provisioned with a key and a certification authority (CA) signed certificate, an embedded controller and/or an application-specific integrated circuit (ASIC). The secure component may comprise the at least one processor 104 or the secure component may be communicatively coupled to the at least one processor 104 which may, for example, be trusted by the secure component.

The instructions 102 comprise instructions 106 to obtain an attestation public key bound to an identity associated with a root of trust of a platform.

An attestation key may comprise an attestation public key and an attestation private key linked to the attestation public key. That is, the attestation public key and attestation private key form an attestation key pair. The attestation private key may be used for signing data as part of the cryptographic authentication procedure.

In some examples where the secure component is a TPM, the key pair may be referred to by a TPM key name (TKN). In some examples, the identity associated with the root of trust of the platform may comprise an endorsement key (EK). In some examples, the attestation key pair (and hence the attestation public and private keys) may be bound to the identity (i.e., the EK). The binding may be logical through a verifying entity (e.g., an OEM) signed certificate that associates the attestation public key and EK. In some examples, the key pair may be generated as a primary object that is derived from a private seed protected and persistent in the TPM or other hardware security module. In some examples, the attestation key is provisioned to the TPM at the time of manufacture (e.g., by the OEM) based on the TPM generating the attestation key from a primary seed that is unique to the TPM. The TPM vendor may then issue a certificate for the attestation key based on the public portion of the attestation key. In some examples, the binding between the key pair and the identity may be further verified before a certificate is issued through a cryptographic challenge-response protocol with the secure component that is capable of demonstrating possession of both keys.

In some examples, the attestation public key may be obtained by accessing a storage (e.g., of the secure component, another trusted entity or another storage of the platform), which may store the attestation public key. For example, the instructions 106 to obtain the attestation public key may comprise instructions to receive the attestation public key from the storage.

In some examples, the attestation private key may be stored in a secure storage of the secure component, which may in some examples be the same storage used to store the attestation public key, if needed.

In some examples, the machine-readable medium 100 may comprise instructions to generate the key pair comprising the attestation public key and the linked attestation private key. In some examples, the instructions 106 to obtain the attestation public key comprise instructions to generate the key pair in order to allow the attestation public key to be obtained (e.g., for further use in certain examples described below). In some examples, the key pair may be generated from a stored high entropy value, which permits regeneration at a later date.

In some examples, the instructions 106 further comprise instructions to store the generated attestation private key in the secure component. The stored attestation private key may be used, for example, as part of a cryptographic authentication procedure involving the secure component.

The instructions 102 further comprise instructions 108 to obtain a trusted time stamp associated with data collection by the platform.

In some examples, the platform may collect data at a certain time, which may be verified with the trusted time stamp. For example, the trusted time stamp may be associated with a certain part of the data collection (e.g., before, during or after the data collection). In some examples, a trusted entity or the secure component may be used to obtain the trusted time stamp. The trusted time stamp may provide an indication that the data was collected by the platform at the time specified by the trusted time stamp.

In some examples, the instructions 108 to obtain the trusted time stamp comprise instructions to cause the at least one processor 104 to generate the trusted time stamp using the attestation private key and an input time associated with the data collection. In some examples, the input time may be derived from the platform itself (e.g., and thereby verified by the secure component).

In some examples, the instructions 108 to obtain the trusted time stamp comprise instructions to cause the at least one processor 104 to receive the trusted time stamp from a trusted entity connected to the platform in response to the platform performing data collection. For example, a network-connected entity such as a server in the factory (e.g., for installing an operating system on the platform) or another trusted entity that is accessible to the platform in the field (e.g., by an authorized user for an update or repair) may be sufficiently trusted to provide the trusted time stamp.

The instructions 102 further comprise instructions 110 to generate, using an attestation private key linked to the attestation public key, a signed measurement based on a trusted input as a nonce.

In some examples, the instructions 110 may comprise instructions to obtain the trusted input (e.g., a nonce such as an input time provided by the secure component, a hash of the input time and/or a signed time received from a trusted entity) and sign the trusted input with the attestation public key. The signed measurement may provide an indication that the trusted input is associated with the secure component and/or that data collected by the platform is associated with the trusted input.

The trusted time stamp and/or the signed measurement may allow a verifying entity such as an OEM to determine that a certain procedure has occurred at an expected time (e.g., the data collection has occurred at an expected time) and/or that the trusted input is associated with the secure component (e.g., via the signed measurement). As will be described in more detail below, the secure component may provide the verifying entity with the information obtained by the instructions 102 so as to enable the verifying entity to determine whether or not the platform is in an expected state.

In some examples, since the information may be bound to the secure component (and the platform itself), the verifying entity may be able to use this information to determine whether the platform (e.g., hardware, software and/or firmware of the platform) or the collected data has been tampered with or is in an unexpected state. Tampering or evidence of the platform being in an unexpected state may be evident from an incorrect or unexpected signed measurement and/or time stamp. In some examples, the information provided (e.g., the information may be sent to a verifying entity such as the OEM) by the instructions 102 may be used to establish that the received data comes from a platform in the factory and/or from a platform in the field that has been reconfigured (e.g., due to an update or repair) in an authorized manner. In some examples, the information provided by the instructions 102 may provide an indication as to whether or not the data has been modified in transit (e.g., due to an attacker submitting false information on behalf of the platform) and/or whether an illicit change has been made to the platform, whether intentional or not.

For example, a verifying entity may receive the information provided by the instructions and check whether or not the information is as expected. In some examples, if the EK certificate is present in the information, the OEM can check whether the EK certificate corresponds to an EK certificate associated with a batch of platforms (e.g., TPMs) sent to the factory. In some examples, a signature applied by the platform to e.g., the EK certificate (if stored by the TPM) or some other input such as expected value (known to the verifying entity) using the attestation private key may be verified by the verifying entity using the attestation public key. In some examples, if the staging server is trusted by the verifying entity, the staging server could be used to verify the EK certificate and provide an indication to the verifying entity as to whether or not the EK certificate can be verified. In some examples, the verifying entity may verify the trusted timestamp (e.g., a timestamp signed by the attestation private key or by another trusted entity) and/or the signed measurement against the attestation public key. Any part of the information which cannot be verified (e.g., the received data from the staging server does not exactly match the expected values) may provide the indication that the data has been modified in transit (e.g., due to an attacker submitting false information on behalf of the platform) and/or that an illicit change has been made to the platform.

Thus, in some examples, it may be possible for a verifying entity to detect a swap attack (e.g., where an attacker registers an illicit identity (such as a TPM EK or identity public key) during manufacturing or in the field), verify binding of the data to the secure component before shipping or in the field and/or strengthen protection against data tampering in data reporting (e.g., as part of diagnostics performed in the factory or due to an update or repair in the field) based on the received information.

FIG. 2 schematically illustrates a machine-readable medium 200 (e.g., a tangible machine-readable medium) which stores instructions 202 which, when executed by at least one processor 204, cause the at least one processor 204 to carry out certain methods described herein.

The instructions 202 comprise the instructions 102 of FIG. 1. Thus, as in FIG. 1, the machine-readable medium 200 may be implemented by a platform such as a computing device. Certain instructions described below may be omitted or implemented in a different order to that indicated in FIG. 2.

In some examples, the instructions 202 comprise instructions 206 to cause the at least one processor to receive, from a trusted entity, the trusted input. In some examples, the trusted input comprises an input time associated with the data collection (e.g., from the secure component). In some examples, the trusted input comprises a signed nonce from a trusted entity such as a trusted network-connected server. The input time may be an example of a nonce. A hash of the input time may also be regarded as an example of nonce. The signed nonce may be any nonce (such as an input time or other nonce) signed by trusted entity (e.g., the verifying entity such as an OEM may trust that the signing entity was the entity that signed the nonce).

In some examples, the instructions 202 comprise instructions 208 to cause the at least one processor 204 to aggregate information indicative of the data collected by the platform at a trusted component of the platform. For example, in the case of a secure component such as a TPM (i.e., a ‘trusted component’), the collected data may be aggregated at or stored in a platform configuration register of the TPM. In another example, the aggregated information may comprise an aggregation summary (e.g., a hash) held securely in the trusted component. In some examples, the trusted component may comprise a trusted storage and/or may comprise the processor itself 204. Thus, in some examples, the collected data may be stored in a manner that changes as events occur (e.g., via a rolling hash of the events associated with device reconfiguration or installation that have occurred) or stored in the trusted storage (e.g., in the form of an installation or reconfiguration log). In some examples, the data may be collected and then aggregated (e.g., summarized and/or hashed) to be held or stored at the trusted component.

The collection of the data may be performed due to installation of an operating system on the platform and/or in response to any diagnostics performed on the platform at any time. The collected data may comprise any data obtained due to the installation and/or diagnostics and/or may comprise any information relating platform such as hardware, software and/or firmware configuration and/or may comprise any platform identifying information such as platform unique values (e.g., universal unique ID (UUID), Feature Byte, etc).

In some examples, the instructions 202 comprise instructions 210 to cause the at least one processor 204 to send the attestation public key, the signed time stamp and the signed measurement to a storage (e.g., a storage of the secure component or the platform and/or a trusted server). For example, the storage may be a storage of the secure component and the instructions 210 may cause the attestation public key, the signed time stamp and the signed measurement to be stored for future use (e.g., to be later sent to a staging server and/or a verifying entity). In another example, the storage may be implemented at the staging server and/or a verifying entity.

In some examples, the instructions 202 further comprise instructions 212 to cause the at least one processor 204 to send, to the storage, certain additional information. The additional information may comprise any of: a certificate indicative of the identity associated with the root of trust of the platform; a log indicative of information obtained by the platform when collecting the data; a measurement indicative of the identity of the platform; and/or a platform identity indicator of the platform.

In some examples, the certificate indicative of the identity may comprise a TPM EK certificate or any other type of certificate that verifies that the identity is associated with the platform.

In some examples, the log may comprise an installer log (e.g., associated with capturing measurements of a diagnostic or other data collection process via a trusted register such as a TPM platform configuration register (PCR), which may keep a rolling hash of all events that have occurred during the data collection process). In some examples, the capturing of the measurements may be initiated by a dynamic root of trust for measurement (DRTM) launch of a network-based installer. In some examples, the log may comprise information relating to the collecting of data (e.g., due to installation, servicing, update or repair).

In some examples, the measurement indicative of the identity of the platform may comprise a measurement of a platform unique value such as a UUID, Feature Byte, etc. In some examples, such measurements may be performed by an embedded controller of the platform and/or due to a basic input/output system (BIOS) measurement (e.g., when booting or re-booting the platform).

In some examples, the platform identity indicator may comprise any value collected that is unique to the platform identity (e.g., a serial number unique to a component of the platform), which may collected during a data collection process (e.g., when booting or re-booting the platform).

In some examples, the instructions 202 further comprise instructions 214 to cause the at least one processor 204 to send a request to a certification authority (CA) and receive a certificate from the certification authority proving that the attestation public key is associated with the platform (e.g., associated with the platform via a measurement signed by the platform using the attestation private key). The instructions 214 further cause the certificate to be sent, by the certification authority, to the storage (e.g., to be accessed by a verifying entity). In some examples, a copy of the certificate is sent to the platform at the same time.

In some examples, the instructions 202 further comprise instructions 215 to cause the at least one processor 204 to send a request to a certification authority (CA) to identify a certificate proving that the attestation public key is associated with the platform (e.g., associated with the platform via a measurement signed by the platform using the attestation private key). The instructions 215 further cause the certificate to be sent, by the certification authority, to the storage (e.g., to be accessed by a verifying entity). In some examples, a copy of the certificate is sent to the platform at the same time that the certification authority identifies the certificate.

The CA may issue a certificate for the identity key (i.e., the attestation key) once it has verified that the measurements in the factory under that key are the same as in the field. The CA can provide this certificate to the platform for storage or return the certificate on request (as referred to in instructions 214, 215) at a later time (e.g., when the platform is in the field). A verifier of the identity key may use the certificate (and the CA root key) to verify that the platform (e.g., still) has the same key at any such time.

In some examples, the instructions 202 further comprise instructions 216 to implement a credential activation procedure. For example, implementing the credential activation procedure may comprise sending, to a certification authority, the attestation public key and/or a public key of a secure component of the platform; receiving, from the certification authority, an encrypted nonce that is encrypted according to a policy that specifies presence of the attestation private key on the secure component to enable decryption of the encrypted nonce by the platform; decrypting the encrypted nonce using the attestation private key; and sending the decrypted nonce to a verifying entity. Thus, in some examples, the verifying entity may perform a credential activation where a challenge response protocol is used to prove that the attestation private key is indeed resident on the secure component. The verifying entity may compare the decrypted nonce received from the platform with the nonce encrypted by the certification authority or the verifying entity may forward the received nonce to the certification authority, which may inform the verifying entity whether or not the nonces match. In this manner, the verifying entity may accept that the collected data is bound to the platform since the use of the attestation key pair may provide proof that the attestation private key is indeed resident on the secure component.

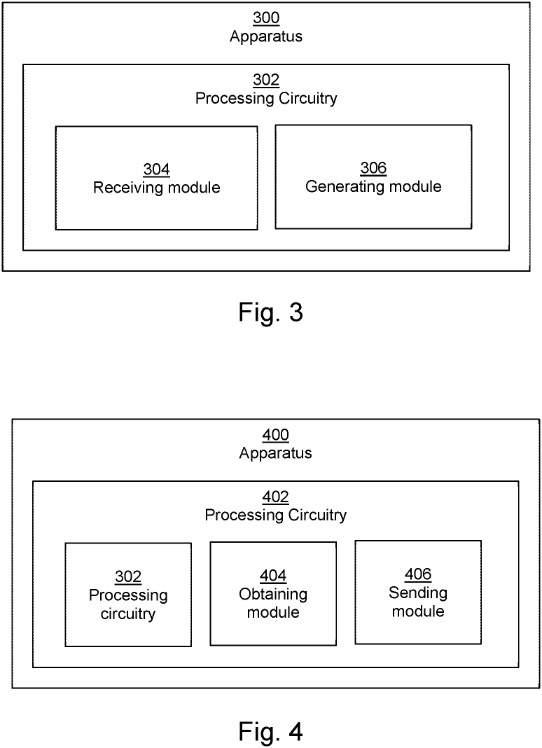

FIG. 3 is a schematic illustration of apparatus 300 for implementing certain methods or the instructions of certain machine-readable media described herein.

The apparatus 300 comprises processing circuitry 302. The processing circuitry 302 may, for example, carry out blocks of certain methods and/or implement functionality corresponding to the instructions stored on certain machine-readable media described herein. For example, the apparatus 300 may implement functionality corresponding to the instructions of the machine-readable media 100, 200 of FIGS. 1 and/or 2.

In some examples, the apparatus 300 comprises or provides the functionality of a secure component such as described above. In some examples, the secure component may comprise or be implemented as a trusted platform module (TPM), smart card provisioned with a key and a certification authority (CA) signed certificate, an embedded controller and/or an application-specific integrated circuit (ASIC). Thus, the secure component of the apparatus 300 may comprise the processing circuitry 302 for implementing the functionality as described below.

In some examples, the apparatus 300 may be implemented by a platform such as a computing device (e.g., a personal computer, laptop, smart device such as a smart phone or other computing device which an OEM might need to authenticate). For example, the computing device may comprise a secure component comprising the apparatus 300.

The processing circuitry 302 comprises a receiving module 304. In use of the apparatus 300, the receiving module 304 receives identifying information associated with data collected by the apparatus 300 and a signed time stamp associated with collection of the data. In some examples, the identifying information comprises any data which can be bound to an identity of the apparatus 300. The signed time stamp may be generated by the apparatus 300 or received from a trusted entity.

The processing circuitry 302 further comprises a generating module 306. In use of the apparatus 300, the generating module 306 generates a signing key based on a primary key of a secure component of the apparatus. The signing key may be an example of an attestation private key. The generating module 306 further generates a signed measurement by using the signing key to sign a trusted input (e.g., corresponding to instructions 110 of FIG. 1). In some examples, a primary key is a key derived from a stored, high entropy seed value. In some examples, the primary key can be re-generated from the seed value.

FIG. 4 is a schematic illustration of apparatus 400 for implementing certain methods or the instructions of certain machine-readable media described herein. The apparatus 400 comprises processing circuitry 402. The processing circuitry 402 comprises the processing circuitry 302 of FIG. 3 for implementing the functionality described in relation to FIG. 3. The modules described below may implement similar functionality as described above in relation to FIGS. 1 and/or 2.

In some examples, the processing circuitry 402 comprises an obtaining module 404. In use of the apparatus 400 and in some examples, the obtaining module 404 obtains the identifying information responsive to a dynamic root of trust for measurement launch of a network-based installer for performing an installation on the apparatus 400 (e.g., in a factory for installing a diagnostics OS on the apparatus 400). In some examples, the identifying information comprises diagnostic information (e.g., an installation log) obtained by the secure component due to the installation and a unique identifier (e.g., a UUID) of the apparatus 400.

In some examples, the obtaining module 404 obtains the identifying information responsive to an update or repair, for example, in the field. For example, a trusted entity may cause the update or repair to be implemented on the apparatus 400 such that certain data is caused to be collected (e.g., via a PCR of the secure component) as part of the update or repair.

In some examples, the processing circuitry 402 comprises a sending module 406. In use of the apparatus 400, the sending module 406 sends, to a third-party entity (e.g., a staging server or verifying entity-controlled server), a public key associated with the signing key, the signed time stamp and the signed measurement. The public key may be an example of an attestation public key.

In some examples, any of the modules described above (e.g., the receiving module 304, generating module 306, obtaining module 404 and/or sending module 406) may comprise at least one dedicated processor (e.g., an application specific integrated circuit (ASIC) and/or field programmable gate array (FPGA), etc) for implementing the functionality of the module.

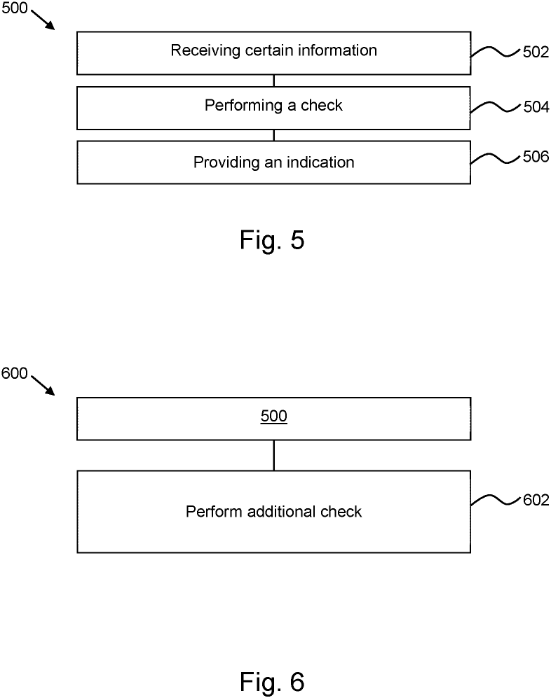

FIG. 5 is a flowchart of an example method 500 for verifying certain information about a platform (e.g., verifying the information received from the factory). For example, this information may be received as a result of implementation or use of certain machine-readable media and/or apparatus described herein. For example, the information may be received from a staging server and/or from the platform itself (e.g., in a factory or in the field). The method 500 may be implemented by a trusted computing device such as controlled by a verifying entity such as an OEM.

The method 500 comprises, at block 502, receiving certain information (e.g., from the staging server, from the device itself and/or from another source such as an OEM-trusted entity).

Block 502 comprises receiving a public key bound to an identity associated with a root of trust of a platform. The public key may be an example of the attestation public key obtained by instructions 104 of FIG. 1.

Block 502 further comprises receiving a signed time stamp indicative of a time of data collection by the platform. The signed time stamp may be an example of the signed time stamp received in accordance with the instructions 106 of FIG. 1.

Block 502 further comprises receiving a signed measurement generated by the platform based on a trusted input. The signed measurement may be an example of the signed measurement generated in accordance with the instructions 108 of FIG. 1.

Thus, in some examples, the information provided and/or authenticated by the secure component described above may be received in block 502 (e.g., as part of package described in more detail below).

The method 500 further comprises performing (e.g., using processing circuitry) a check (e.g., a pre-validation check while the platform is in the factory) at block 504.

In some examples, the check 504 comprises determining whether the identity of the platform corresponds to an expected identity by using a previously-received identity for the platform. For example, the previously-received identity may correspond to a primary key certificate such as an EK certificate assigned to the platform by a CA. For example, the verifying entity may control a trusted database comprising, for example, the EK certificates and/or a pre-determined serial number of the secure component and/or platform supplied to the factory (e.g., by a component vendor). The verifying entity may be able to determine the expected identity for the platform based on the previously-received identity. For example, the previously-received identity may be combined with certain information associated with the platform (e.g., expected data to be collected and/or a unique platform identifier) to determine the expected identity (e.g., the public key) for the platform.

In some examples, the check 504 comprises determining whether the signed time stamp corresponds to an expected time stamp by using the public key. For example, the verifying entity may be able to determine that the time that the data was collected by the platform corresponds to an expected time that the platform was in the factory and/or that the platform is being updated or repaired by an authorized user in the field at an expected time. In some examples, the public key may be used to establish that the time stamp is associated with a time of data collection by the platform.

In some examples, the check 504 comprises determining whether the signed measurement corresponds to an expected measurement by using the public key. For example, the verifying entity may be able to determine that the measurement is bound to the platform by using the public key.

In response to the check being indicative that the platform is in an unexpected state (e.g., any one or combination of the above examples failing the check or providing an unexpected result), the method 500 comprises providing an indication, at block 506, that the platform is in the unexpected state. Thus, in some examples, the method 500 may alert the verifying entity to the possibility that the platform or the data has been tampered with.

In some examples, the verifying entity may be able to determine that a secure component swap attack has occurred during the manufacture of the platform. For example, a primary key of the secure component may be securely bound to certain data collected by the platform and the verifying entity may determine that the reported data does not correspond to the expected data if either the primary key has been swapped or different data has been collected. In some examples, the verifying entity may be able to determine that the secure component is bound to the data before shipping, to prevent or identify illicit or erroneous platforms being distributed in the field.

In some examples, the verifying entity may receive a package comprising the data and then perform the check. For example, the verifying entity may have access to a trusted database comprising an indication of the identities (e.g., an EK certificate) of the secure component(s) sent to the factory and check whether the identity is an expected identity (e.g., by performing a signature check on a certificate stored in the database). If the check is not valid, the platform comprising the secure component may be flagged as potentially illicit or at least in an unexpected state. In some examples, a staging server may verify whether the identity is an expected identity.

In some examples, the package may comprise: an identity such as a TPM EK certificate, a log of collected data (e.g., associated with an installation, update or repair implemented by the platform), configuration data corresponding to the platform (e.g., hardware, software, firmware and/or any other identifying information associated with the platform), a public key (e.g., the attestation public key), a signed time stamp and a signed measurement. In some examples, certain information may not be provided with the package and/or may be accessible from another trusted entity such as an OEM-controlled database. For example, the identity may not be provided as part of the package but may be accessible from the trusted entity.

In some examples, the verifying entity may verify the signed time stamp using the public key (e.g., of the platform). In some examples, another public key associated with a trusted entity for providing a signed time stamp (e.g., to be received by the platform) may be used to verify that the time stamp is indeed trusted and/or associated with the platform.

In some examples, the verifying entity may verify the signed measurement (for example, comprising a signature over a hash of events) using the public key to verify that the hash of events is indeed trusted and/or associated with the platform.

In some examples, performing the check further comprises re-computing data collected by the platform using a log of measurements used to produce aggregate information indicative of the data collected by the platform (e.g., where the log is available to the verifying entity). For example, providing a log of events or enough information is available to reproduce the log, it may be possible to re-compute the data. For example, well defined ‘events’ could be based on status codes, or other short hand that can be used to generate the log events that went into the aggregate information. In some examples, such log events or associated information may be generated (and thereby become accessible to the verifying entity) in response to an installation being performed on the platform, a repair or update being implemented on the platform and/or due to the platform being reconfigured in some way.

In some examples, performing the check comprises re-computing data collected by the platform using: installation data obtained due to an installation implemented on the platform; a unique identifier of the platform; the public key; the signed time stamp and the signed measurement. In some examples, performing the check comprises re-computing data collected by the platform using: data obtained due to a repair or update implemented on the platform; a unique identifier of the platform; the public key; the signed time stamp and the signed measurement.

If any part of the above example checks fail, the verifying entity may indicate that the platform is to be rejected. For example, a remediation flow may be triggered such as labelling the platform as tampered, requesting an audit on the factory, flagging a logistics chain to intercept the platform and/or warn a customer/end user of the platform.

In some examples, the check may verify the as-built data collected by the platform, for example, to ensure that the in-factory interaction or in-field interaction between the platform and the verifying entity can be trusted.

In some examples, the method 500 may allow the verifying entity to collect data about the platform, which is bound securely to a yet-unknown identity rooted in a root of trust such as a TPM. The verifying entity may pre-validate the platform when it is in the factory and then, as will be described below, the validation may be completed once the platform is in the field or connected to the network. In some examples, second-touch customization flows may be supported, which may allow a verifying entity to instill trust in the manufacturing process for an end user or another entity that customizes the platform.

FIG. 6 is a flowchart of an example method 600 for verifying certain information about a platform (e.g., when the platform is in the field). The method 600 comprises the method 500 of FIG. 5 to depict the method 600 when the verifying entity performs a pre-validation check (e.g., when the platform is in the factory). The additional block of the method 600 depicts the method 600 when the verifying entity performs a further check to complete the validation. In some examples, the block 500 may be omitted entirely since the pre-validation check may be performed when the platform is in the factory while the method 600 is concerned with completing the validation check (e.g., when the platform is in the field). Thus, when in the field, the platform does not need to perform block 500 in order to implement the rest of the method 600. In some examples, the method 600 may be implemented by a trusted computing device such as controlled by a verifying entity such as an OEM.

The method 600 comprises, at block 602, performing an additional check. The additional check comprises causing data (e.g., a nonce) encrypted under the public key (e.g., an ‘attestation public key’) of the platform to be sent to the platform along with a policy that specifies that a private key (e.g., an ‘attestation private key’) linked to the public key is present on the platform in order to decrypt the data. Block 602 further comprises determining whether or not the private key is present on the platform depending on whether the data is returned by the platform (e.g., the nonce is returned). Thus, if the data (e.g., nonce) is returned correctly, this provides proof that the private key is resident on the platform. In some examples, performing the additional check comprises causing the platform to provide an indicator (e.g., a ‘private key possession indicator’) of a private key (e.g., an ‘attestation private key’) held by the platform and determining whether or not the data collected from the platform is bound to the platform based on the indicator received from the platform. In the case of block 602, the private key possession indicator is the decrypted data.

In some examples, whether the platform is in the factory or in the field, the platform may be able to perform an online connection to the verifying entity with a privacy certification authority (PCA) and perform a credential activation based on knowledge of the public key of the key pair to determine proof of possession of the private key associated with the secure component. If the private key is proven to be on the stated secure component based on the credential activation, then it may be possible for the verifying entity to accept that the data collected by the platform is bound to that platform. In other similar words, the verifying entity may check that the private key belongs to the platform and verify whether or not the private key is correct for the platform. In the example involving the instructions 216 described above, the indication of the private key may comprise the decrypted nonce sent to the verifying entity by the platform. Thus, in some examples, a request may be sent to the PCA and/or the platform to cause the PCA to send an encrypted nonce to the platform (according to a policy that specifies presence of the private key on the secure component to enable decryption of the encrypted nonce by the platform), which in turn indicates whether it holds the private key via the decrypted nonce sent to the verifying entity and/or PCA.

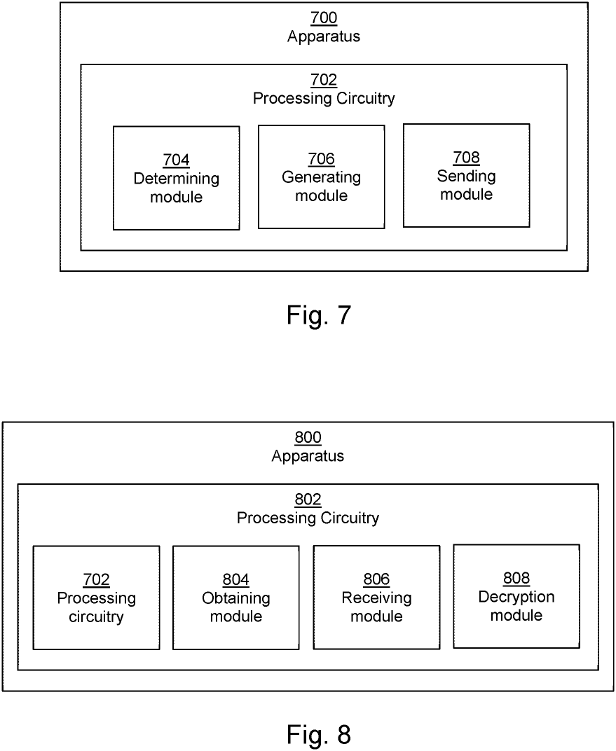

FIG. 7 is a schematic illustration of apparatus 700 for implementing certain methods or the instructions of certain machine-readable media described herein.

The apparatus 700 comprises processing circuitry 702. In use of the apparatus 700, the processing circuitry 702 may, for example, carry out blocks of certain methods and/or implement functionality corresponding to the instructions stored on certain machine-readable media described herein. For example, the apparatus 700 may implement functionality corresponding to the instructions of the machine-readable media 100, 200 of FIGS. 1 and/or 2. The apparatus 700 may be used in conjunction with other methods. For example, the methods 500, 600 may be implemented by a verifying entity such as an OEM, and the apparatus 700 may interact with (i.e., send data to/from) the verifying entity.

The processing circuitry 702 comprises a determining module 704 to determine a trusted time (e.g., the apparatus itself or another trusted entity may provide a time, in a similar manner to that described in relation to instructions 108).

The processing circuitry 702 further comprises a generating module 706 to generate an attestation key pair bound to an identity associated with a root of trust of the apparatus (e.g., in a similar manner to implementing instructions 106). In use of the apparatus 700, the generating module 706 further generates a signed time stamp based on the trusted time and a private key (e.g., an attestation private key) of the attestation key pair (e.g., in a similar manner to implementing instructions 108). The generating module 706 further generates a signed measurement based on a trusted input (e.g., a nonce) and the private key (e.g., in a similar manner to implementing instructions 110).

The processing circuitry 702 further comprises a sending module 708. In use of the apparatus 700, the sending module 708 sends a public key (e.g., an attestation public key) of the attestation key pair, the signed time stamp and the signed measurement to a verifying entity (e.g., an OEM).

FIG. 8 is a schematic illustration of apparatus 800 for implementing certain methods or the instructions of certain machine-readable media described herein. The apparatus 800 comprises processing circuitry 802. The processing circuitry 802 comprises the processing circuitry 702 of FIG. 7 for implementing the functionality described in relation to FIG. 7. The modules described below may implement similar functionality as described above in relation to FIGS. 1 and/or 2.

In some examples, the processing circuitry 802 comprises an obtaining module. In use of the apparatus 800, the obtaining module 804 obtains identifying information collected by the apparatus 800 responsive to a change of state of the apparatus. In some examples, the identifying information comprises information associated with data collected by the apparatus 700, 800, a signed time stamp associated with collection of the data and/or platform unique values (e.g., universal unique ID (UUID), Feature Byte, etc.). As part of the information the sending module 708 (see apparatus 700/processing circuitry 702) sends to the verifying entity, after obtaining the identifying information, the sending module 708 also sends this identifying information to the verifying entity.

In some examples, the processing circuitry 802 comprises a receiving module 806 to receive, from the verifying entity, a request comprising data (e.g., a nonce) encrypted under the public key and a policy specifying that the data is to be decrypted if the private key is held on the apparatus 800. The processing circuitry 802 further comprises a decryption module 808 to decrypt the data using the private key, where the sending module is to send the decrypted data (e.g., the decrypted nonce) to the verifying entity. Thus, in some examples, the combination of the receiving module 806 and the decryption module 808 implements the functionality of the platform referred to in block 602 (i.e., block 602 implements the functionality of the verifying entity referred to in relation to the apparatus 700, 800).

In some examples, the key pair may be assigned a device ID (DevID) via a certificate provisioning flow (e.g., to provision a certificate associated with the key pair), which may provide additional proof that the key pair and/or corresponding certificate is bound to the platform.

In some examples, any of the modules described above (e.g., the determining module 704, generating module 706, sending module 708, obtaining module 804, receiving module 806 and/or decryption module 808) may comprise at least one dedicated processor (e.g., an application specific integrated circuit (ASIC) and/or field programmable gate array (FPGA), etc) for implementing the functionality of the module.

Examples in the present disclosure can be provided as methods, systems (e.g., apparatus comprising processing circuitry with modules having functionality corresponding to blocks of methods or instructions of machine-readable media) or as a combination of machine-readable instructions and processing circuitry. Such machine-readable instructions may be included on a non-transitory machine (for example, computer) readable storage medium (including but not limited to disc storage, CD-ROM, optical storage, etc.) having computer readable program codes therein or thereon.

The present disclosure is described with reference to flow charts and block diagrams of the method, devices and systems according to examples of the present disclosure. Although the flow charts described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine readable instructions.

The machine-readable instructions may, for example, be executed by a general purpose computer, a special purpose computer, an embedded processor or processors of other programmable data processing devices to realize the functions described in the description and diagrams. In particular, a processor or processing circuitry, or a module thereof, may execute the machine-readable instructions. Thus functional modules of the apparatus 300, 400, 700, 800 (for example, the receiving module 304, generating module 306, obtaining module 404, sending module 406, determining module 704, generating module 706, sending module 708, obtaining module 804, receiving module 806 and/or decryption module 808) and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine-readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or in the block diagrams.

Further, the teachings herein may be implemented in the form of a computer program product, the computer program product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the scope of the present disclosure. It is intended, therefore, that the method, apparatus and related aspects be limited by the scope of the following claims and their equivalents. It should be noted that the above-mentioned examples illustrate rather than limit what is described herein, and that many implementations may be designed without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A tangible machine-readable medium comprising instructions which, when executed on at least one processor, cause the at least one processor to:
obtain an attestation public key bound to an identity associated with a root of trust of a platform;
obtain a trusted time stamp associated with data collection by the platform; and
generate, using an attestation private key linked to the attestation public key, a signed measurement based on a trusted input as a nonce.

2. The tangible machine-readable medium of claim 1, where the instructions to obtain the trusted time stamp comprise instructions to cause the at least one processor to generate the trusted time stamp using the attestation private key and an input time associated with the data collection.

3. The tangible machine-readable medium of claim 1, where the instructions to obtain the trusted time stamp comprise instructions to cause the at least one processor to receive the trusted time stamp from a trusted entity connected to the platform in response to the platform performing data collection.

4. The tangible machine-readable medium of claim 1, comprising instructions to cause the at least one processor to receive, from a trusted entity, the trusted input, where the trusted input comprises an input time associated with the data collection.

5. The tangible machine-readable medium of claim 1, comprising instructions to cause the at least one processor to aggregate information indicative of the data collected by the platform at a trusted component of the platform.

6. The tangible machine-readable medium of claim 1, comprising instructions to cause the at least one processor to send the attestation public key, the signed time stamp and the signed measurement to a storage.

7. The tangible machine-readable medium of claim 6, further comprising instructions to cause the at least one processor to send, to the storage:
a certificate indicative of the identity associated with the root of trust of the platform;
a log indicative of information obtained by the platform when collecting the data;
a measurement indicative of the identity of the platform; and/or
a platform identity indicator of the platform.

8. The tangible machine-readable medium of claim 6, further comprising instructions to cause the at least one processor to:
send a request to a certification authority and receive a certificate from the certification authority proving that the attestation public key is associated with the platform; and
cause the certificate to be sent, by the certification authority, to the storage.

9. The tangible machine-readable medium of claim 1, further comprising instructions to:
send, to a certification authority, the attestation public key and a public key of a secure component of the platform;
receive, from the certification authority, an encrypted nonce that is encrypted according to a policy that specifies presence of the attestation private key on the secure component to enable decryption of the encrypted nonce by the platform;
decrypt the encrypted nonce using the attestation private key; and
send the decrypted nonce to a verifying entity.

10. A method, comprising:
receiving:
a public key bound to an identity associated with a root of trust of a platform;
a signed time stamp indicative of a time of data collection by the platform; and
a signed measurement generated by the platform based on a trusted input; performing, using processing circuitry, a check comprising determining whether:
the identity of the platform corresponds to an expected identity by using a previously-received identity for the platform;
the signed time stamp corresponds to an expected time stamp by using the public key; and/or
the signed measurement corresponds to an expected measurement by using the public key; and
in response to the check being indicative that the platform is in an unexpected state, providing an indication that the platform is in the unexpected state.

11. The method of claim 10, where performing the check further comprises re-computing data collected by the platform using a log of measurements used to produce aggregate information indicative of the data collected by the platform.

12. The method of claim 10, comprising performing an additional check, where the additional check comprises causing data encrypted under the public key of the platform to be sent to the platform along with a policy that specifies that a private key linked to the public key is present on the platform in order to decrypt the data, the method further comprising determining whether or not the private key is present on the platform depending on whether the data is returned by the platform.

13. Apparatus comprising processing circuitry, the processing circuitry comprising:
a determining module to determine a trusted time;
a generating module to:
generate an attestation key pair bound to an identity associated with a root of trust of the apparatus;
a signed time stamp based on the trusted time and a private key of the attestation key pair; and
a signed measurement based on a trusted input and the private key; and a sending module to:
send a public key of the attestation key pair, the signed time stamp and the signed measurement to a verifying entity.

14. The apparatus of claim 13, comprising an obtaining module to:
obtain identifying information collected by the apparatus responsive to a change of state of the apparatus, and where the sending module is to send the identifying information to the verifying entity.

15. The apparatus of claim 13, comprising:
a receiving module to receive, from the verifying entity, a request comprising data encrypted under the public key and a policy specifying that the data is to be decrypted if the private key is held on the apparatus;
a decryption module to decrypt the data using the private key, where the sending module is to send the decrypted data to the verifying entity.
